(19) United States
(12) Patent Application Publication
(10) Pub. No.: US 2005/0025930 A1
(43) Pub. Date: Feb. 3, 2005

(54) Carpet manufactured with polyurethane coating process and having integral padding

(76) Inventors: Glen Hamrick, Tunnel Hill, GA (US); Paul Walker, Dalton, GA (US); Jerry Lindsay, Rocky Face, GA (US)

Correspondence Address: DOUGLAS T. JOHNSON;MILLER & MARTIN, 1000 VOLUNTEER BUILDING, 832 GEORGIA AVENUE, CHATTANOOGA, TN, 37402-2289, US

(21) Appl. No.: 10/902,232

(22) Filed: Jul. 29, 2004

Related U.S. Application Data
(60) Provisional application No. 60/491,030, filed on Jul. 30, 2003.

(51) Int. Cl. B32B 33/00; B05D 3/12; B05D 3/04

(52) U.S. Cl. 428/95; 427/355; 427/389.9; 427/377

(57) ABSTRACT

A method for preparing a carpet with an integral polyurethane foam carpet pad utilizing a water blown chemistry results in an economical and improved product. The polyurethane is evenly distributed on a spun bond film material, steamed, calendared to a uniform height and cured without the use of a curing oven.

### PRIORITY

This application claims priority to U.S. provisional application Ser. No. 60/491,030 filed on Jul. 30, 2003.

### FIELD OF THE INVENTION

The present invention relates to improved methods and materials for adhering a polyurethane foam backing to a carpet to create carpet with integral padding.

### BACKGROUND OF THE INVENTION

Polyurethanes are produced in four different principal forms including elastomers, coatings, flexible foams, and cross-linked foams. Polyurethane foams are produced by reacting isocyanate compounds with polyol compounds generally in the presence of catalysts, surfactants, and other auxiliary agents. At the start of polyurethane foam production, the reactive raw materials are held as liquids in large, stainless steel tanks. These tanks are equipped with agitators to keep the materials fluid. A metering device is attached to the tanks so that the appropriate amount of the reactive material can be pumped out. Generally, the ratio of polyol to isocyanate is about 1:2; and the ratio of components is strictly metered to control the characteristics of the resulting polymers. The reacting materials are then mixed and dispensed. Reaction between the isocyanate and the polyol, usually referred to as the gel reaction, leads to the formation of a polymer of high molecular weight. This reaction increases the viscosity of the mixture and generally contributes to cross-link formation. The second major reaction occurs between isocyanate and water. This reactive produces carbon dioxide gas which promotes foaming causing the volume of the urethane polymer to grow. In some instances, auxiliary blowing agents are added to further increase the volume of the polymer.

Both the gel and blow reactions occur in foams blown partially or totally with carbon dioxide gas. In order to obtain a good urethane foam structure, the gel and blow reactions must proceed simultaneously and at optimum balance rates. For example, if the carbon dioxide generation is too rapid in comparison with the gel reaction, the foam tends to collapse. Alternatively, if the gel reaction is too rapid in comparison with the blow reaction generating carbon dioxide, the rise of the foam will be restricted resulting in high density form. In practice, the balancing of these two reactions is controlled by the natures of catalysts and auxiliary agents used in the process.

Most flexible water blown polyurethane foams are produced by molded or slab foam processes. Foam molding is a process where individual polyurethane foam items are produced by poring the foam chemicals into specially shaped molds and allowing the foam reaction to take place. This process is used for automotive cushioning and some contract furniture cushions.

The slab process involves dispensing the pre-polymer chemical mix onto a moving conveyor where it is allowed react and expand rising into a slab typically between two and four feet in height. The continuous slab is sliced and allowed to finish curing. Most cushions in furniture and bedding are produced in this fashion. Most prime polyurethane carpet cushion is made from slices of slab stock polyurethane foam.

Another type of carpet cushion is made from bonded polyurethane foam. This bonded polyurethane foam is created by shredding scrap polyurethane foam into small pieces and placing the pieces into a processing unit with a chemical adhesive. The mixture is pressurized and injected with steam to form a large foam cylinder or block. This material is then peeled at the proper thickness for carpet cushion. A plastic film backing is then typically applied with adhesive and the finished carpet cushion is packaged in rolls. In some instances, however, polyurethane foam pads may be formed directly on a film.

The present invention is directed to forming an integral carpet pad or cushion on carpet. Carpet is most commonly manufactured by tufting yarns through a primary backing to form the greige, with cut or loop pile bights of yarns on one side of the primary backing forming the face of the carpet and back stitches of yarns on the other side of the backing. A coating is applied to the back stitches and primary backing to create good tuft bind or fiber lock and thereby prevent the yarns from pulling out of the primary backing. In most instances, the coating will also adhere a secondary backing to the greige, resulting in the finished carpet.

Typically, latex is used as the coating to anneal the yarns to the primary backing and adhere the secondary backing. Secondary backings are commonly made of jute or polyethylene or polyester scrim. However, polyurethane adhesives may be advantageously used as coatings, and nonwoven or spunbanded nylons, polypropylenes, polyesters, polyethylenes and similar polymers may be used as secondary backings. Most carpets are sold separately from carpet pads, which are used both to increase the comfort of the carpet and extend the useful life of the carpet. It would be desirable to produce a carpet having a secondary backing and an integral carpet pad.

Numerous difficulties are encountered when applying polyurethane ingredients directly to a carpet backing to create a polyurethane foam suitable for use as a carpet pad. For instance, one critical property of a carpet pad produced by this method is annealing strength, or the force required to separate the backing from the polyurethane foam pad. Difficulties can arise in achieving sufficient annealing strength when applying polyurethane foam to a backing because once the pre-polymers have been mixed and polymerization has begun, the polyurethane soon begins to lose its adhesive properties. In addition, when polyurethane is applied to the backing, even minor irregularities in thickness across the width of the backing may lead to substantial differences in the ultimate height of the foam after it is fully blown. The rapid curing of polyurethane, especially in the presence of water, which is the preferred blowing agent, also causes difficulties by clogging the mixing and dispensing components. Finally, heating is generally required in order to cure the blown polyurethane foam and typical curing temperatures of 111° C. to 130° C. for ten to thirty minutes not only adds substantial energy costs and slows the production speeds, but also may even shrink some types of carpet fibers that would otherwise advantageously be used. It would, therefore, be desirable to provide a carpet having a polyurethane foam pad annealed thereto without requiring a separate adhesive layer and providing even foam height while avoiding clogging of the dispensing apparatus and the necessity for heat curing the product.

### SUMMARY OF INVENTION

The present invention pertains to a polyurethane foam system for manufacturing integral carpet and carpet padding with a combination of advantages over the prior art. The polyurethane foam is substantially water blown with a substantial part of the water applied to the mixture subsequent to the pre-polymers being dispensed upon the film and in this fashion avoiding premature polymerization and the necessity of a lengthy heat curing step. Furthermore, the backing to which the polyurethane foam is annealed without a separate application of adhesive is preferably an inexpensive spun bonded fabric made of nylon, polypropylene, polyester, polyethylene or similar polymers. The single application of polyurethane, without any separate adhesive or annealing precoat decreases raw material costs and manufacturing time. In addition, blowing and curing the polyurethane foam at ambient temperature decreases manufacturing time and expense, and avoids shrinkage or damage to face yarns. These advantages, combined with the low cost of spun bonded backing significantly increase the commercial utility and economic viability of the product.

### BRIEF DESCRIPTION OF DRAWINGS

FIG. 1 illustrates a preferred dispensing apparatus for applying mixed polyurethane components to a carpet backing.

FIGS. 2a and 2b illustrate front and side views of a preferred construction of the dies used to dispense the polyurethane components onto the backing.

FIG. 3 is an alternatively preferred dispensing apparatus for mixing and dispensing the polyurethane components onto the backing.

FIG. 4 illustrates the process of creating a polyurethane foam carpet pad on a carpet backing according to the present invention.

FIG. 5 illustrates an alternative embodiment of the process of creating the polyurethane foam carpet pad on the carpet backing.

### DETAILED DESCRIPTION OF THE INVENTION

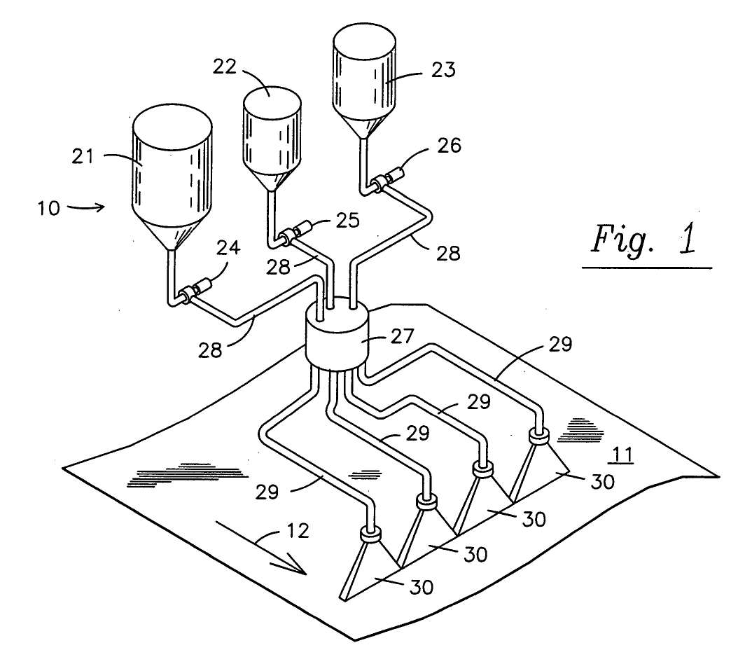

The present invention is designed to provide an improved and less expensive polyurethane foam carpet pad annealed to a carpet backing. Referring now to the drawings in more detail, FIG. 1 illustrates a preferred dispensing apparatus for mixed polyurethane onto the backing. The secondary backing 11, preferably in the form of spun bonded nylon, polypropylene, polyester, polyethylene, or similar fibers, and preferably with a calendared surface, is fed in direction 12 past the dispensing apparatus 10. Some woven fabrics may also be suitably used as a secondary backing 11. The dispensing apparatus 10 preferably comprises a polyol tank 21, iso tank 22, and catalyst tank 23. Polyol tank 21 contains ployol mixed with filler and surfactants, such as silicone. The iso tank 22 contains isocynate. The catalyst tank 23 contains catalyst and a small amount of water. Typically, there will be between fifty and two hundred parts filler per hundred parts of polyol and no more than 5 parts of water per hundred parts of polyol. Contents of polyol tank 21 are pumped by pump 24 through tube 28 to mix head 27. The temperature of the polyol mixture maybe controlled either by refrigerating the entire polyol tank 21 or by passing tube 28 through a heat exchanger to achieve the desired temperature prior to mixing. Similarly, the contents of iso tank 22 are pumped by iso pump 25 through tube 28 to mix head 27 and contents of catalyst tank 23 are pumped by pump 26 through another tube 28 to mix head 27. There may be an additional input line to mix head 27 for air or inert gas in order to increase the frothing of the mixture in mix head 27. All of the ingredients may be temperature controlled as described in connecting with the polyol mixture above. In addition. there may be other additives such as stabilizers, antioxidants, antimicrobials, anti-mildew agents, colorants, flame retardants, and chain extenders, all depending upon the characteristics desired in the resulting foam. The illustrated mix head 27 dispenses polyurethane mixture through outlet tubing 29 to a plurality of die heads 30 extending across a substantial width of the backing fabric 11. In this embodiment, is anticipated that each individual die head will be between about four and twelve inches in width, and preferably between about six to nine inches in width.

The pumps 24, 25, 26 precisely meter the constituent components of the polyurethane. Mix head 27 not only mixes and froths the components but also evenly controls the distribution of the polyurethane mixture to each of the die heads 30. After the mixture of the polyurethane components, outlet tubes 29 from the mix head 27 may also pass through heat exchanger apparatus to alter the viscosity and reaction time of the polyurethane.

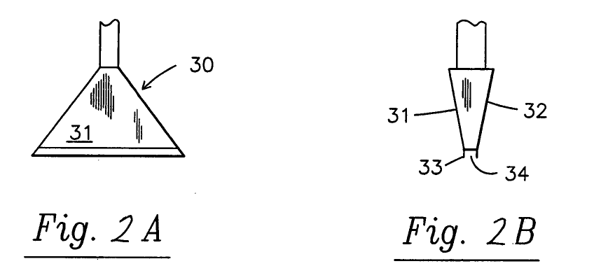

Back pressure helps keep the distribution of the material exiting the die heads 30 consistent and even across the width of the backing 11. The die head lips 33 shown in FIG. 2 may be adjusted depending upon the amount of polyurethane material to be applied. At least one of the die lips 33 can be permitted to touch the back of the backing 11, or both lips may be raised to avoid contact with backing 11.

To control the cost of the polyurethane backing according to the present invention, the polyurethane components (polyol and iso) may be applied at weights of only about 6 to 12 ounces per square yard with good results. Heavier and more expensive backings may be applied with polyurethane components at weights up to about 40 ounces per yard.

The adhesion of the polyurethane material to the backing 11 may be accomplished by the use of a roller, a doctor blade, controlled vacuum, ultrasonic waves or an air knife, and in some instances, by the viscosity of the polyurethane material. The preferred spun bond materials have a weight of between about 1.5 and 4 ounces per square yard, and are calendared or texturized. Adhesion to the preferred spun bonded films is not difficult.

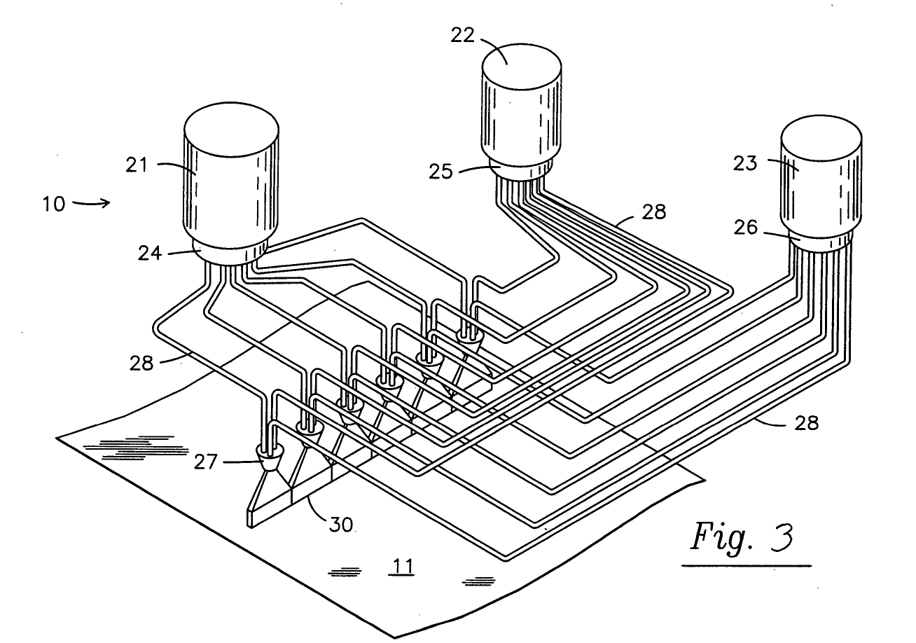

FIG. 3 illustrates an alternative embodiment for applying mixed polyurethane components to backing 11. In this instance, tanks 21, 22, 23, pumps 24, 25, 26 to convey the polyurethane components through inlet tubes 28 to a plurality of a small mix heads 27 that are substantially directly connected to die heads 30. This structure permits the polyurethane components to be blended and dispersed without passing through mix head outlet tubes 29, such as illustrated in FIG. 1. By placing the mix head closer to the actual application of the polyurethane components, there is less time for a reaction to occur before the components are on the backing 11, thereby reducing the chance of clogging the dispensing apparatus.

The modules of FIGS. 1 and 3 may be repeated across a wider film than illustrated, typically, up to approximately four or five meters in total width.

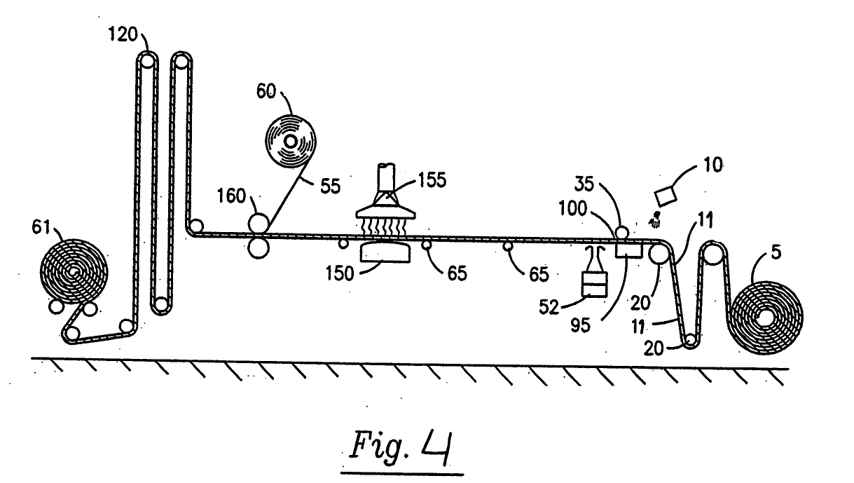

FIG. 4 illustrates the process of creating an integral carpet and carpet pad according to the present invention. A roll 5 of carpet with backing 11 is fed over tensioning rollers 20 to the polyurethane dispenser 10 according to the invention. While the source of carpet is depicted as roll 5, it is also possible that greige would be processed directly in line after affixing the secondary backing. A doctor blade or roll 35 over a metering plate 95 helps to even the application of the polyurethane, or when woven films are used to insure some penetration of the fabric. Optionally, a vacuum device 52 may be utilized to increase the penetration of the polyurethane. Carpet with backing 11 passes over additional rollers to steam ducts 150 and fume head 155 which provides sufficient water for the polyurethane to blow and create a foam polyurethane layer on backing 11. In addition, the water and heat accelerate the curing of the polyurethane. The film and polyurethane foam layers are then passed over a gauging roller 160 which slightly crushes the polyurethane foam to a desired height. This roller may or may not be used to emboss the foam with a calendared design, as its principle purpose is to halt the increased volumization of the film layer and to help even any irregularities in the height of the foam layer. The foam backed carpet then passes over take-up rollers 120 and is finally wound on take-up roll 61. In order to create an economical and serviceable foam pad on the carpet, polyurethane is applied to the backing 11 at about six to forty ounces per square yard and preferably at a rate of about twelve ounces per square yard.

Conspicuously absent in this process is an oven-curing step. An oven is not necessary in the process because the polyurethane components are essentially kept separate until very shortly before their application to the backing 11, and, therefore, need not be treated to retard the rate of polymerization. Apart from the step passing the polyurethane treated film over a steam hood, the other steps of the process are generally maintained within 20° C. of ambient temperature, or in a more preferred embodiment within 10° C. of ambient temperature during manufacturing process.

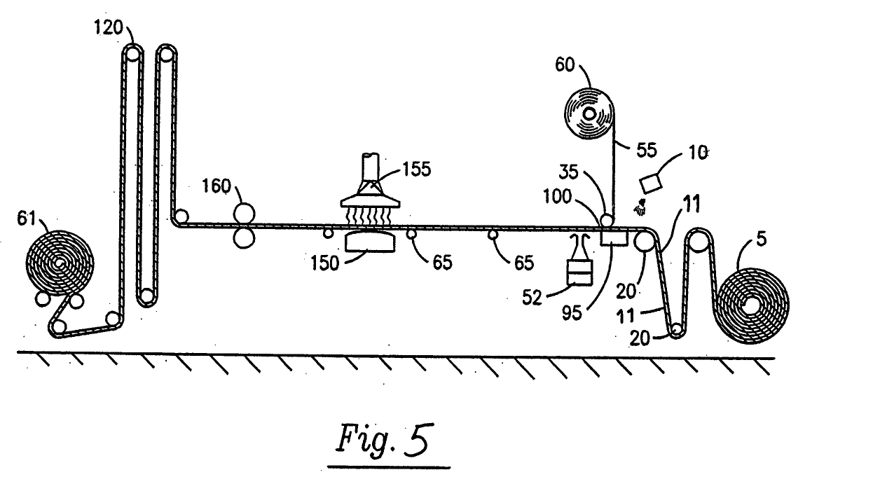

If desired, a tertiary backing 55 may be dispensed and applied to the top of the polyurethane foam in order to cover the foam pad with a spun bonded film or fabric. As illustrated in FIG. 5, such a film may be applied over the polyurethane even before passing under the doctor blade or roller 35 that helps even the application of polyurethane on film 11. Alternatively, as illustrated in FIG. 4, such a tertiary backing 55 may be applied by the calendaring roller 160. Other positions between rollers 35 and 160 may also suitably be employed to apply the tertiary backing 55.

Other techniques of applying polyurethane to a film, such as those disclosed in WO 031039869, which is incorporated herein, may also be suitably employed in some instances. In all of the foregoing embodiments, the figures have been simplified for clarity and to ease viewing and understanding. In commercial embodiments, additional devices, e.g. drive motors, tension devices, etc. will be required.

Polyurethane pre-polymers useful in the practice of the present invention are prepared by the reaction of active hydrogen compounds with any amount of isocyanate in a stoichiometric excess relative to active hydrogen material.

The pre-polymer formulations of the present invention include a polyol component. Active hydrogen containing compounds most commonly used in polyurethane production are those compounds having at least two hydroxyl groups or amine groups. However, any active hydrogen containing compound can be used with the present invention, and indeed some soy based oils can be used.

In the practice of the present invention, preferably at least 50 weight percent of the active hydrogen compounds used to prepare the polyurethane is a polyol having molecular weight of from about 100-400.

The polyisocyanate component of the formulations of the present invention can be prepared using any organic polyisocyanates, modified polyisocyanates, isocyanate based pre-polymers and mixtures thereof. These can include aliphatic or aromatic isocyanates. Preferably the isocyanate used to prepare the pre-polymer formulation of the present invention is methyl diisocyanates such as Bayer's 142L or Dow p901 or blends of equal type.

Catalysts suitable for use in preparing the polyurethane of the present invention include tertiary amines, and organometallic compounds and mixtures thereof. For example, suitable catalysts include stannous octoate, triethylenediamine, N-methyl morpholine, like compounds and mixtures thereof. The catalysts do not necessarily need elevated activation temperatures or other promoters to initiate polymerization.

Surfactants can be useful for preparing a stable dispersion of the present invention. Surfactants useful for preparing a stable dispersion can be cationic, anionic, or non-ionic surfactants. Preferably the surfactants used to prepare the pre-polymer formulation of the present invention are silicone surfactants such as Dow Corning DC-194 or Union Carbide's L-540. A surfactant can be included in a formulation of the present invention in an amount ranging from about 0.01 to about 7 parts per 100 parts by weight of the polyol component.

A compound of the present invention optionally includes a filler material. The filler material can include conventional fillers such as milled glass, calcium carbonate, aluminum trihydrate, barium sulfate, fly ash, dyes and pigments or fire retardants (aluminum trihydrate and Tris polyolefin glycol). When employed, filler is typically in amounts of about 50 to 200 parts per 100 parts of polyol, but may range upwards to even 400 parts.

Although a preferred embodiment of the present invention has been disclosed herein, it will be understood that various substitutions and modifications may be made to the disclosed embodiment described herein without departing from the scope and spirit of the present invention as recited in the appended claims.

1. A method for preparing a carpet with an integral carpet pad by annealing flexible polyurethane foam to a secondary backing of the carpet, said process comprising:
(a) preparing polyurethane by introducing polyol from a first dedicated line and a isocynate from a second dedicated line into a mixing head with a filler, a catalyst, water, and a gas to froth the ingredients;
(b) directing the frothed ingredients to a die head;
(c) applying said polyurethane ingredients to form a coating on the secondary backing of the carpet;
(d) evening the distribution of the polyurethane ingredients substantially across the width of the secondary backing;
(e) applying steam to the polyurethane coated carpet to increase gel and blow reactions; and
(f) passing the polyurethane coated carpet through a gauging device to level the blown polyurethane.

2. The method of claim 1 wherein the water is added to the ingredients in the mixing head at a rate of less no more than 5 parts per 100 parts of polyol.

3. The method of claim 1 wherein the polyurethane in the foam has a weight of between about 6 ounces to about 40 ounces per square yard.

4. The method of claim 1 wherein a filler is added to the mixing head at a rate of between 0 and 400 parts of filler to 100 parts of polyol.

5. The method of claim 1 wherein the secondary backing comprises a spun bond material.

6. The method of claim 1 wherein the secondary backing is a calendared material.

7. The method of claim 1 wherein the distribution of polyurethane ingredients substantially across the width of the secondary backing is accomplished by use of at least one of a doctor blade, a roller, or an air knife.

8. The method of claim 1 wherein the polyol and isocynate are at a controlled temperature before entering the mix head.

9. The method of claim 8 wherein the temperature of the polyol and isocynate are controlled by refrigeration.

10. The method of claim 1 wherein the mixing head is adjacent to the die head.

11. The method of claim 1 wherein the mixing head is connected to a plurality of die heads by relatively short connecting tubes passing through a heat exchanger to alter the viscosity of the polyurethane ingredients.

12. The method of claim 1 wherein a dispensing opening of the die head is adjustable.

13. The method of claim 1 wherein a tertiary backing is applied to the coating of polyurethane ingredients.

14. A carpet with integral carpet pad comprising greige having a face side and an opposed coated side; a flexible polyurethane foam layer having a first side, an opposed second side, and a polyurethane weight of between about 6 and about 40 ounces per square yard, said first side being annealed to the coated side of the greige.

15. The carpet with integral carpet pad of claim 14 further consisting of a tertiary layer of spun bond material annealed to the second side of the flexible polyurethane foam layer.

16. The carpet with integral carpet pad of claim 14 wherein a secondary backing is annealed to the coated side of the greige between the greige and the flexible foam layer.

17. The carpet with integral carpet pad of claim 16 wherein the secondary backing is a spun bond material having a weight of between about 1.5 and 4 ounces per square yard.

18. The carpet with integral carpet pad of claim 14 wherein the coated side of the greige is coated with polyurethane.

19. The carpet with integral carpet pad of claim 15 wherein the tertiary layer of spun bond material is calendarized.

20. The carpet with integral carpet pad of claim 14 wherein the polyurethane weight is less than 12 ounces per square yard.
